(19) United States
(12) Patent Application Publication
(10) Pub. No.: US 2010/0275572 A1
(43) Pub. Date: Nov. 4, 2010

(54) OIL LINE INSULATION SYSTEM FOR MID TURBINE FRAME

(75) Inventors: Eric DUROCHER, Vercheres (CA); Pierre-Yves LEGARE, Chambly (CA)

Correspondence Address: OGILVY RENAULT LLP (PWC), 1, PLACE VILLE MARIE, SUITE 2500, MONTREAL, QC, H3B 1R1, CA

(73) Assignee: PRATT & WHITNEY CANADA CORP., Longueuil, QC (CA)

(21) Appl. No.: 12/433,163

(22) Filed: Apr. 30, 2009

(51) Int. Cl. F01D 25/18; F02C 7/20; F02C 7/24

(52) U.S. Cl. 60/39.08; 60/797; 415/177

(57) ABSTRACT

A gas turbine engine having a mid turbine frame comprising an annular outer case providing a portion of an engine casing; an interturbine duct (ITD) disposed within the outer case, the ITD including outer and inner rings radially spaced apart one from another and being interconnected by a plurality of radially extending and circumferentially spaced hollow strut fairings, the inner and outer rings co-operating to provide a portion of a hot gas path through the engine; a tube for delivering or discharging a lubricant fluid to or from a bearing housing, the tube extending radially through one of the hollow struts; and an insulation structure radially extending through one said hollow strut fairing, the insulation structure surrounding the tube and being spaced apart from the tube and from a hot internal surface of the one hollow strut fairing for shielding the tube from heat radiated from the hot internal surface of the one hollow strut fairing and for preventing the lubricant fluid from contacting the hot internal surface of said one hollow strut fairing when lubricant fluid leakage occurs.

### TECHNICAL FIELD

The invention relates generally to gas turbine engines and more particularly to an oil line insulation system for a mid turbine frame of a gas turbine engine.

### BACKGROUND OF THE ART

A mid turbine frame (MTF) system, sometimes referred to as an interturbine frame, is located generally between a high turbine stage and a low pressure turbine stage of a gas turbine engine to support one or more bearings and to transfer bearing loads through to an outer engine case, and also to form an interturbine duct (ITD) for directing a hot gas flow to the downstream rotor. It is conventional to have a conduit carrying a lubricant fluid to pass through one of radial hollow struts disposed in the ITD. The struts are exposed to the hot gas flow in the ITD and therefore an insulation system is demanded because the hot temperature may cause lubricant degradation or even lubricant ignition if lubricant leakage occurs.

Accordingly, there is a need to provide an improved oil line insulation system.

### SUMMARY

According to one aspect, provided is a gas turbine engine having a mid turbine frame, the mid turbine frame comprising: an annular outer case providing a portion of an engine casing; an interturbine duct (ITD) disposed within the outer case, the ITD including outer and inner rings radially spaced apart one from another and being interconnected by a plurality of radially extending and circumferentially spaced hollow strut fairings, the inner and outer rings co-operating to provide a portion of a hot gas path through the engine; a tube for delivering or discharging a lubricant fluid to or from a bearing housing, the tube extending radially through one of the hollow struts; and an insulation structure radially extending through one said hollow strut fairing, the insulation structure surrounding the tube and being spaced apart from the tube and from a hot internal surface of the one hollow strut fairing, for shielding the tube from heat radiated from the hot internal surface of the one hollow strut fairing and for preventing the lubricant fluid from contacting the hot internal surface of said one hollow strut fairing when lubricant fluid leakage occurs.

According to another aspect, provided is a gas turbine engine comprising: a portion of an annular hot gas path, said portion being defined between outer and inner rings radially spaced and interconnected by a plurality of radially extending and circumferentially spaced hollow struts; a section of a lubricant line for circulating a lubricant fluid, said section of the lubricant line extending radially through one of said hollow struts; and means for shielding the section of the lubricant line from heat radiated from a hot internal surface of said one hollow strut and for preventing the lubricant fluid from contacting the hot internal surface of said one hollow strut when lubricant fluid leakage associated with said section of the lubricant line occurs.

Further details of these and other aspects of the present invention will be apparent from the detailed description and figures included below.

### DESCRIPTION OF THE DRAWINGS

Reference is now made to the accompanying drawings, in which:

FIG. 1 is a schematic cross-sectional view of a turbofan gas turbine engine according to the present description;

FIG. 2 is a cross-sectional view of the mid turbine frame system having a lubricant line insulation system according to one embodiment;

FIG. 3 is rear elevational view of the mid turbine frame system of FIG. 2, with a segmented strut-vane ring assembly and rear baffle removed for clarity;

FIG. 4 is a perspective view of an outer case of the mid turbine frame system; and

FIG. 5 is a partially exploded perspective view of the mid turbine frame system of FIG. 2, showing a segmented strut-vane ring assembly in the mid turbine frame system.

### DETAILED DESCRIPTION

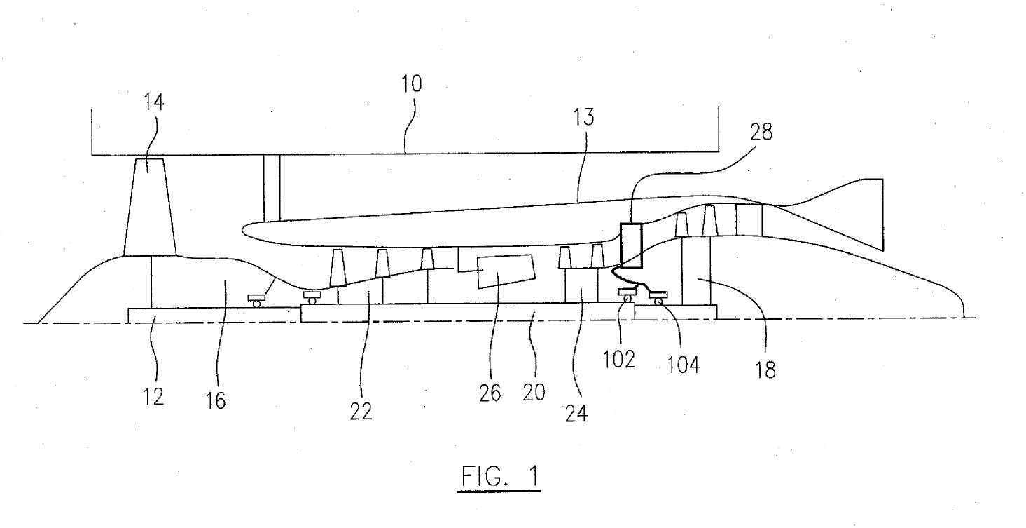

Referring to FIG. 1, a bypass gas turbine engine includes a fan case 10, a core case 13, a low pressure spool assembly which includes a fan assembly 14, a low pressure compressor assembly 16 and a low pressure turbine assembly 18 connected by a shaft 12, and a high pressure spool assembly which includes a high pressure compressor assembly 22 and a high pressure turbine assembly 24 connected by a turbine shaft 20. The core case 13 surrounds the low and high pressure spool assemblies to define a main fluid path therethrough. In the main fluid path there is provided a combustor 26 to generate combustion gases to power the high pressure turbine assembly 24 and the low pressure turbine assembly 18. A mid turbine frame system 28 is disposed between the high pressure turbine assembly 24 and the low pressure turbine assembly 18 and supports bearings 102 and 104 around the respective shafts 20 and 12.

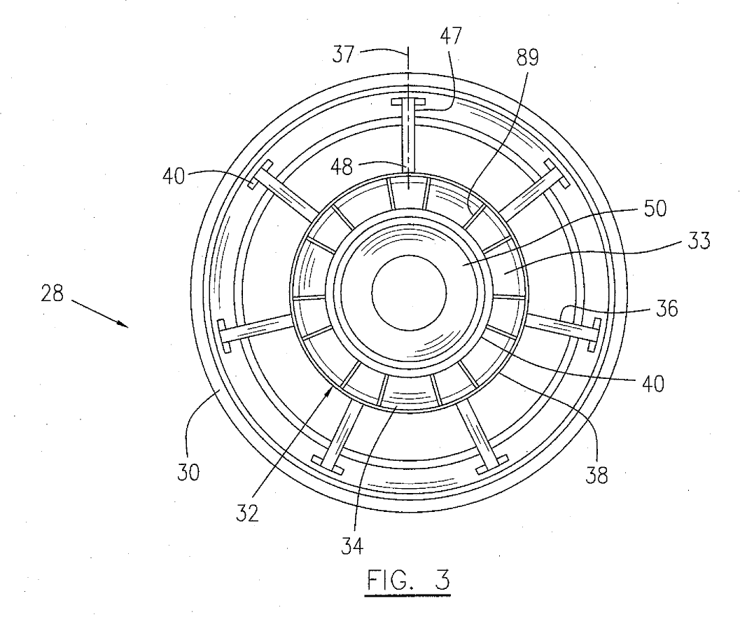

Referring to FIGS. 1-4 the mid turbine frame system 28 includes an annular outer case 30 which has mounting flanges (not numbered) at both ends with mounting holes therethrough (not shown), for connection to other components (not shown) which co-operate to provide the core case 13 of the engine. The outer case 30 may thus be a part of the core case 13. A spoke casing 32 includes an annular inner case 34 coaxially disposed within the outer case 30 and a plurality of (at least three, but seven in this example) load transfer spokes 36 radially extending between the outer case 30 and the inner case 34. The inner case 34 generally includes an annular axial wall 38 and truncated conical wall 33 smoothly connected through a curved annular configuration 35 to the annular axial wall 38 and an inner annular wall 31 having a flange (not numbered) for connection to a bearing housing 50, described further below. A pair of gussets or stiffener ribs 89 (see also FIG. 3) extends from conical wall 33 to an inner side of axial wall 38 to provide locally increased radial stiffness in the region of spokes 36 without increasing the wall thickness of the inner case 34. The spoke casing 32 supports a bearing housing 50 which surrounds a main shaft of the engine such as shaft 12, in order to accommodate one or more bearing assemblies therein, such as those indicated by numerals 102, 104 (shown in FIG. 1). The bearing housing 50 is centered within the annular outer case 30 and is connected to the spoke casing 32, which will be further described below.

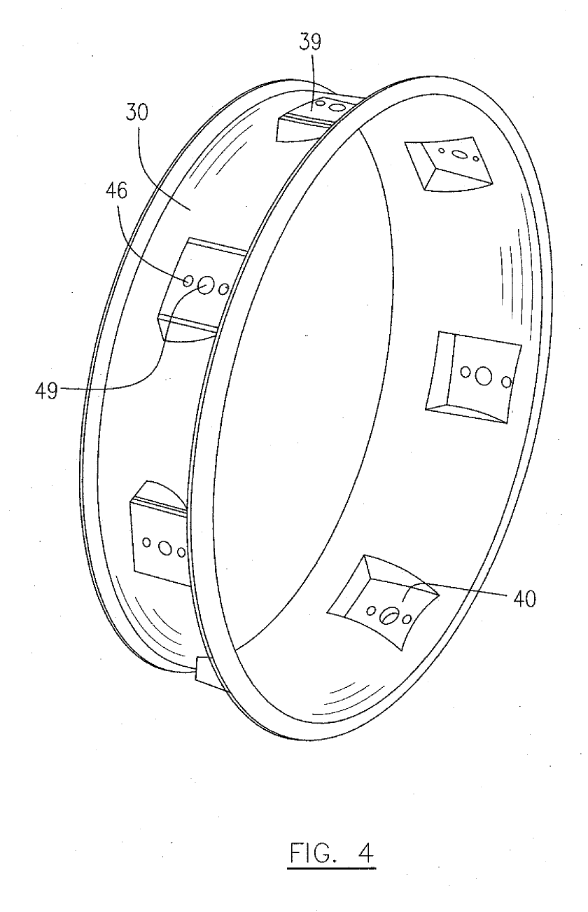

The load transfer spokes 36 are each connected at an inner end 48 thereof, to the axial wall 38 of the inner case 34, for example by welding or fasteners. The spokes 36 are hollow with an inner cavity 78 therein. Each of the load transfer spokes 36 is connected at an outer end 47 thereof, to the outer case 30, by a plurality of fasteners 42. The fasteners 42 extend radially through openings 46 (see FIG. 4) defined in the outer case 30, and into holes 44 defined in the outer end 47 of the spoke 36.

The load transfer spokes 36 each have a central axis 37 and the respective axes 37 of the plurality of load transfer spokes 36 extend in a radial plane (i.e. the paper defined by the page in FIG. 3).

The outer case 30 includes a plurality of (seven, in this example) support bosses 39, each being defined as having a flat base substantially normal to the spoke axis 37. Therefore, the load transfer spokes 36 are generally perpendicular to the flat bases of the respective support bosses 39 of the outer case 30. The support bosses 39 are formed by a plurality of respective recesses 40 defined in the outer case 30. The recesses 40 are circumferentially spaced apart one from another corresponding to the angular position of the respective load transfer spokes 36. The openings 49 with inner threads (not shown), are provided through the bosses 39. The outer case 30 in this embodiment has a truncated conical configuration in which a diameter of a rear end of the outer case 30 is larger than a diameter of a front end of the outer case 30. Therefore, a depth of the boss 39/recess 40 varies, decreasing from the front end to the rear end of the outer case 30. A depth of the recesses 40 near to zero at the rear end of the outer case 30 to allow axial access for the respective load transfer spokes 36 which are an integral part of the spoke casing 32. This allows the spokes 36 to slide axially forwardly into respective recesses 40 when the spoke casing 32 is slide into the outer case 30 from the rear side during mid turbine frame assembly.

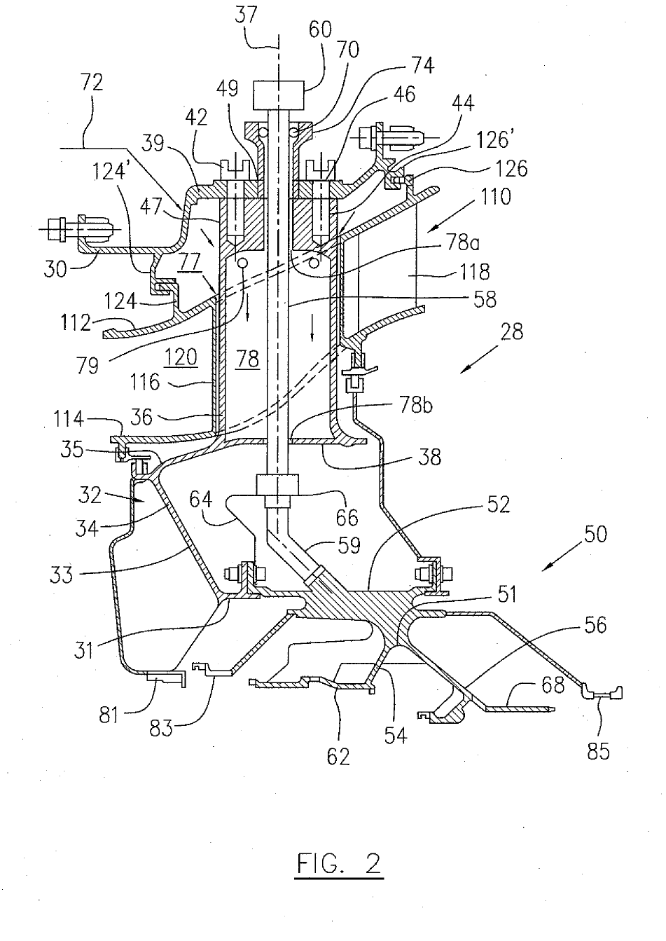

In FIGS. 2-4, the bearing housing 50 includes an annular axial wall 52 detachably mounted to an annular inner end of the truncated conical wall 33 of the spoke casing 32, and one or more annular bearing support legs for accommodating and supporting one or more bearing assemblies, for example a first annular bearing support leg 54 and a second annular bearing support leg 56 according to one embodiment. The first and second annular bearing support legs 54 and 56 extend radially and inwardly from a common point 51 on the axial wall 52 (i.e. in opposite axial directions), and include axial extensions 62, 68, which are radially spaced apart from the axial wall 52 and extend in opposed axial directions, for accommodating and supporting the outer races axially spaced first and second main shaft bearing assemblies 102, 104 (shown in FIG. 1).

Additional support structures may also be provided to support seals, such as seal 81 supported on the inner case 34, and seals 83 and 85 supported on the bearing housing 50.

Referring to FIGS. 1 and 2, the mid turbine frame system 28 may be optionally provided with a plurality of radial locators 74 for radially positioning the spoke casing 32 (and thus, ultimately, the bearings 102, 104) with respect to the outer case 30. Each of the radial locators 74 has a central passage (not numbered) extending therethrough. The number of radial locators may be less than the number of spokes. The radial locators 74 may be radially adjustably attached to the outer case 30, for example threadedly received in the respective openings 49, and abutting the outer end of the respective load transfer spokes 36. The radial locators 74 are adjusted before the fasteners 42 are tightened.

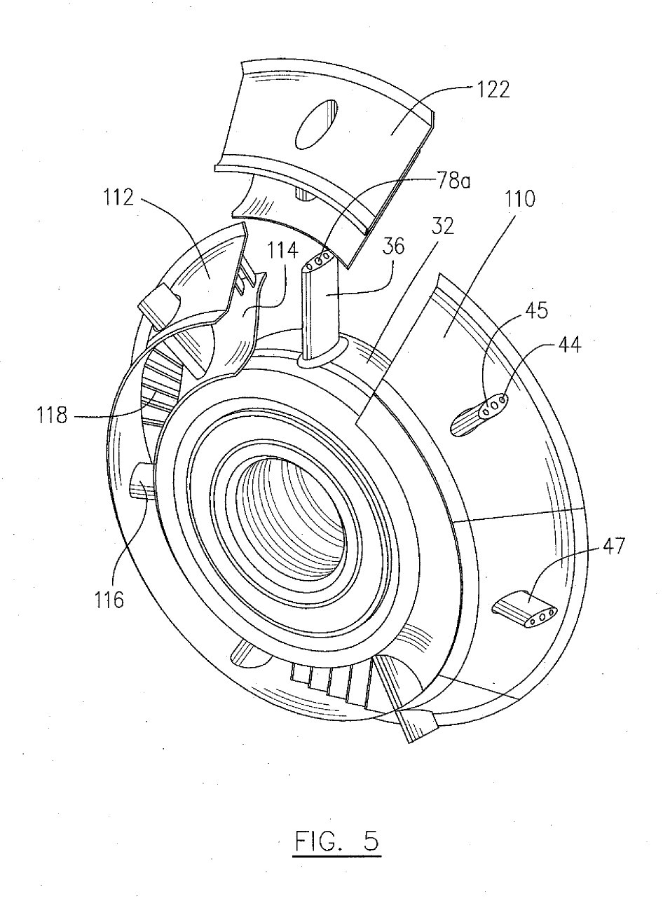

Referring to FIGS. 2 and 5, the mid turbine frame system 28 may include an interturbine duct (ITD) assembly 110, such as a segmented strut-vane ring assembly (also referred to as an ITD-vane ring assembly), disposed within and supported by the outer case 30. The ITD assembly 110 includes coaxial outer and inner rings 112, 114 radially spaced apart and interconnected by a plurality of radial hollow struts 116 (at least three) and a plurality of radial airfoil vanes 118. The number of hollow struts 116 is less than the number of the airfoil vanes 118 and equivalent to the number of load transfer spokes 36 of the spoke casing 32. The hollow struts 116, function substantially as a structural linkage between the outer and inner rings 112 and 114. The hollow struts 116 are aligned with openings (not numbered) defined in the respective outer and inner rings 112 and 114 to allow the respective load transfer spokes 36 of the spoke casing 32 to radially extend through the ITD assembly 110 to be connected to the outer case 30. The hollow struts 116 also define an aerodynamic airfoil outline to form a fairing to reduce fluid flow resistance to combustion gases flowing through an annular gas path 120 defined between the outer and inner rings 112, 114. The airfoil vanes 118 are employed substantially for directing these combustion gases. Neither the struts 116 nor the airfoil vanes 118 form a part of the load transfer link as shown in FIG. 4 and thus do not transfer any significant structural load from the bearing housing 50 to the outer case 30. The load transfer spokes 36 which each are spaced apart from a hot inner surface of the struts 116, provide a so-called “cold strut” arrangement, as they are protected from high temperatures of the combustion gases by the surrounding wall of the respective struts 116, and the associated air gap between struts 116 and spokes 36, both of which provide a relatively “cold” working environment for the spokes to react and transfer bearing loads, In contrast, conventional “hot” struts are both aerodynamic and structural, and are thus exposed both to hot combustion gases and bearing load stresses.

The ITD assembly 110 includes for example, a plurality of circumferential segments 122. Each segment 122 includes a circumferential section of the outer and inner rings 112, 114 interconnected by only one of the hollow struts 116 and by a number of airfoil vanes 118. Therefore, each of the segments 122 can be attached to the spoke casing 32 during an assembly procedure, by inserting the segment 122 radially inwardly towards the spoke casing 32 and allowing one of the load transfer spokes 36 to extend radially through the hollow strut 116. Suitable retaining elements or vane lugs 124 and 126 may be provided, for example, towards the upstream edge and downstream edge of the outer ring 112 (see FIG. 2), for engagement with corresponding retaining elements or case slots 124′, 126′, on the inner side of the outer case 30.

A portion of the annular axial wall 38 of the inner case 34 forms an inner end wall (not numbered) of each load transfer spoke 36 at least one of the load transfer spokes 36 defines an aperture 78b in its inner end wall (see FIG. 2). Another aperture 78a is defined in the thickened outer end wall (not numbered) of each load transfer spoke 36, aligning with the aperture 78b and the central passage (not numbered) of the radial locator 74, thereby allowing a tube 58 to extend radially into the outer case 30 and through the load transfer spoke 36, being spaced apart from the load transfer spoke 36. The tube 58 is a section of a lubricant line (not shown) of the engine for delivering lubricant fluid to the bearing housing 50. The tube 58 has a connector 60 at its outer end for connection to the lubricant line of a lubricant system (not shown) of the engine. An inner end of the tube 58 is connected to a connector 66 mounted to a support structure 64. The support structure 64 is attached by for example, by fasteners (not numbered) to the bearing housing 50. Another bent tube 59 is connected between the connector 66 and the bearing housing 50 such that lubricant fluid flow from the engine lubricant system may be delivered through the tubes 58 and 59 into internal passages (not shown) of the bearing housing 50 for lubricating and cooling bearings 102, 104 of FIG. 1.

One or more holes 79 is provided in the load transfer spoke 36, in fluid communication with the inner cavity 78 within the load transfer spoke 36 and an outer cavity 77 which is defined radially between the outer case 30 and the outer ring 112 and around the outer end portion of the load transfer spoke 36 which projects radially outwardly from the outer ring 112. The outer cavity 77 is in fluid communication with pressurized cooling air such as compressor P3 air, via an external air line 72. A seal 70 may be provided around the tube 58 in a central passage (not numbered) of the radial locator 74, thereby sealing an annular gap (not numbered) defined by the aperture 78a, between the tube 58 and the thickened outer end wall of the load transfer spoke 36. At the inner end of the load transfer spoke 36, the aperture 78b defines an annular gap between the tube 58 and the inner end wall of the load transfer spoke 36.

The load transfer spoke 36 which is a structural component of the MTF 28 for transferring loads from the bearing housing 50 to the outer case 30, also functions as a lubricant line insulation structure for shielding the tube 58 from heat radiating from the hot internal surface (not numbered) of the hollow strut 116 and prevents the lubricant fluid from contacting the hot internal surface of the hollow strut 116 when lubricant fluid leakage occurs. Furthermore, the load transfer spoke 36 defines a first air passage formed by holes 79, the inner cavity 78 and the aperture 78b to direct an air flow from the outer cavity 77 which contains pressurized air received from the external air line 72, to pass through and to be discharged into the inner case 34. The number and size of the holes 79, the inner cavity 78 and the size of the aperture 78b may be optionally designed to provide a minimum flow rate of the air flow passing through the inner cavity 78 to create a flow velocity high enough to vent any leaked lubricant fluid accumulated within the inner cavity 78. The load transfer spoke 36 further defines an air passage formed by the gap between the load transfer spoke 36 and the hot inner surface of the hollow strut 116 for directing cooling air from the outer cavity 77 to pass therethrough, for cooling the hot inner surface of the strut 116 and insulating the load transfer spoke 36 from heat radiated from the hot inner surface of the strut 116.

The load transfer spokes 36 as shown in FIG. 2, is used as an oil line insulation structure for the tube 58 which delivers lubricant fluid to the bearing housing 50, and additionally, one or two other load transfer spokes 36 of the spoke casing 32 may be similarly configured to function as a lubricant line insulation structure for tubes used as lubricant scavenging conduits for directing used lubricant fluid from the bearing housing 50 back to the lubricant system of the engine.

The load transfer spokes 36 illustrated in FIG. 2 are integral parts of the spoke casing 32, however it should be noted that the above-described subject matter is applicable to load transfer struts otherwise connected (for example detachably connected by fasteners) to a support structure in an MTF.

The above description is meant to be exemplary only, and one skilled in the art will recognize that changes may be made to the embodiments described without departing from the scope of the subject matter disclosed. For example, the ITD assembly may be configured differently from that described and illustrated in this application and engines of various types other than the described turbofan bypass duct engine will also be suitable for application of the described concept. The lubricant line insulation system in accordance with the described subject may also be applicable for annular hot gas path ducts other than those of ITD's of MTF's of gas turbine engines. Still other modifications which fall within the scope of the described subject matter will be apparent to those skilled in the art, in light of a review of this disclosure, and such modifications are intended to fall within the appended claims.

1. A gas turbine engine having a mid turbine frame, the mid turbine frame comprising:
an annular outer case providing a portion of an engine casing;
an interturbine duct (ITD) disposed within the outer case, the ITD including outer and inner rings radially spaced apart one from another and being interconnected by a plurality of radially extending and circumferentially spaced hollow strut fairings, the inner and outer rings co-operating to provide a portion of a hot gas path through the engine;
a tube for delivering or discharging a lubricant fluid to or from a bearing housing, the tube extending radially through one of the hollow struts; and
an insulation structure radially extending through one said hollow strut fairing, the insulation structure surrounding the tube and being spaced apart from the tube and from a hot internal surface of the one hollow strut fairing, for shielding the tube from heat radiated from the hot internal surface of the one hollow strut fairing and for preventing the lubricant fluid from contacting the hot internal surface of said one hollow strut fairing when lubricant fluid leakage occurs.

2. The gas turbine engine as defined in claim 1, wherein the insulation structure is formed by one of a plurality of load transfer spokes, the load transfer spokes having a hollow configuration and radially extending through selected hollow strut fairing for transferring loads from the bearing housing to the outer case.

3. The gas turbine engine as defined in claim 2 wherein one of said load transfer spokes is connected at an outer end thereof to the outer case and at an inner end thereof to a structure supporting the bearing housing, thereby defining an inner cavity within said one load transfer spoke and an aperture in respective outer and inner end walls of said one load transfer spoke in order to allow the tube to radially extend through said one load transfer spoke.

4. The gas turbine engine as defined in claim 3 wherein the outer case and the outer ring in co-operation, define an outer cavity radially therebetween and around an outer section of said one load transfer spoke radially projecting from the outer ring, the outer cavity being in fluid communication with pressurized cooling air, thereby allowing the pressurized cooling air to enter a gap between said one load transfer spoke and the one hollow strut fairing for cooling the one hollow strut fairing.

5. The gas turbine engine as defined in claim 4 wherein the one load transfer spoke defines at least one inlet hole in fluid communication with both the outer cavity and the inner cavity, thereby introducing a vent air flow into the inner cavity for venting the leaked lubricant fluid.

6. The gas turbine engine as defined in claim 5 wherein the aperture in the inner end wall of said one load transfer spoke defines a gap between the tube and the inner end wall for discharging the vent air flow from the inner cavity.

7. The gas turbine engine as defined in claim 3 further comprising a seal device for sealing a gap between the tube and the outer end wall of said one load transfer spoke.

8. The gas turbine engine as defined in claim 1 further comprising a support device attached to the bearing housing for supporting the tube in place.

9. A gas turbine engine comprising:
a portion of an annular hot gas path, said portion being defined between outer and inner rings radially spaced and interconnected by a plurality of radially extending and circumferentially spaced hollow struts;
a section of a lubricant line for circulating a lubricant fluid, said section of the lubricant line extending radially through one of said hollow struts; and
means for shielding the section of the lubricant line from heat radiated from a hot internal surface of said one hollow strut and for preventing the lubricant fluid from contacting the hot internal surface of said one hollow strut when lubricant fluid leakage associated with said section of the lubricant line occurs.

10. The gas turbine engine as defined in claim 9 further comprising a first air passage for directing a vent air flow to vent the leaked lubricant fluid.

11. The gas turbine engine as defined in claim 10 wherein the first air passage is configured to direct a minimum flow rate of the vent air flow at a flow velocity high enough for ventilation of the leaked lubricant fluid.

12. The gas turbine engine as defined in claim 9 further comprising a second air passage for directing a cooling air flow to cool said one hollow strut.

13. The gas turbine engine as defined in claim 9 wherein the means comprises a hollow load transfer spoke radially extending through said one hollow strut for transferring loads from a bearing housing to an engine casing in which the portion of the annular hot gas path is disposed.

14. The gas turbine engine as defined in claim 13 wherein the hollow load transfer spoke defines an inner cavity therein and an aperture in respective opposed outer and inner ends, to allow the section of the lubricant line to radially extend therethrough.

15. The gas turbine engine as defined in claim 14 wherein the inner cavity is in fluid communication with pressurized air to cause a vent air flow to pass through the inner cavity for ventilation of leaked lubricant fluid.

16. The gas turbine engine as defined in claim 13 wherein the hollow load transfer spoke is spaced apart from the hot inner surface of said one hollow strut, to thereby define an air passage between the hollow load transfer spoke and the hot inner surface of said one hollow strut, the air passage being in fluid communication with pressurized air in order to provide a cooling air flow to cool the hot inner surface of said one hollow strut.
